(19) United States
(12) Patent Application Publication
(10) Pub. No.: US 2003/0031535 A1
(43) Pub. Date: Feb. 13, 2003

(54) Wafer positioning check in vertical semiconductor furnaces

(75) Inventors: Ming-Feng Yu, Hsinchu (TW); Kuen-Chyr Lee, Tainan (TW); Yi-Li Hsiao, Chiai (TW); Cheng-Hsun Chan, Tainan (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 09/928,263

(22) Filed: Aug. 10, 2001

(51) Int. Cl. B65G 49/07

(52) U.S. Cl. 414/160

(57) ABSTRACT

A wafer positioning checking system used in a vertical furnace as found in a semiconductor manufacturing facility for manufacturing chips. The system utilizes a first sensor such as a photoelectric or laser sensor that checks the peripheral alignment of the wafers loaded in the boat. A second sensor is mounted on a robot having a wafer-handling arm for checking the position of a wafer that has just been loaded into the boat. An algorithm in a control unit responds to electrical signals generated by these two sensors to allow the loading operation to continue as long as the wafers are properly positioned and to controllable monitoring the wafers during a portion of the processing.

### FIELD OF THE INVENTION

The present invention relates in general to vertical semiconductor furnaces for manufacturing semiconductor devices, such as integrated circuits, and deals more particularly to checking the position of quartz boats in the furnace.

### BACKGROUND OF THE INVENTION

U.S. Pat. No. 6,223,096 entitled “Elevator System For Transferring a Wafer Boat With Automatic Horizontal Attitude Control” issued on Apr. 24, 2001 which is incorporated herein by reference, teaches an elevator system that automatically adjusts the inclination a wafer boat during the manufacturing of the semiconductor devices. This ensures that the wafers in the boat are maintained horizontal during their processing in the furnace. The elevator system includes the wafer boat, a base on which the boat is supported and an elevator for loading the boat into a processing chamber and removing it from the chamber. In addition there is a sensing unit for detecting the inclination of the boat relative to the horizontal. A horizontal control unit is interposed the base and the elevator and is drivable to maintain the boat in such a position to maintain the wafers in horizontal planes in the boat. A control unit receives the information from a sensing unit and, based on the information, outputs a control signal to the horizontal driving units. This system does not check the position or the condition of the wafer in the boat after the wafer is loaded.

U.S. Pat. No. 6,002,516 entitled “Vertical Cassette Elevator and Load Lock Viewer” issued on Dec. 14, 1999 and assigned to a common assignee, a system for readily observing wafers when disposed in a vertical cassette elevator or in a load lock during transfer into and out of a fabrication processing system. This system provides an optical system allowing an operator to visually view the interior of the fabrication system. This prior art does not continuously monitor the positioning and the condition of the wafer during the processing. This patent is incorporated herein in its entirety by reference only.

### SUMMARY OF THE INVENTION

It is difficult to see by visual means the fine wafer position in a quartz boat in a vertical furnace system when calibrating the system. It is therefore a principal advantage of this system to utilize a plurality of sensors to check both vertical and horizontal alignment of the wafers automatically and continuously.

It is yet another advantage of the present system to prevent the wafer from sliding out, being scratched, broken or dropped during transfer of the wafers within the system due its constant monitoring.

It is another advantage of the present system to automatically check the wafer position in every run of the processing of the vertical furnace.

It is yet still another advantage of the present system to guide the wafer as it is being loaded on the forks of the boat to prevent breaking of the wafers and the resulting cross contamination on the other wafers.

These and other advantages will become apparent from the following wafer positioning checking system in a vertical semiconductor furnace, having a wafer storage stage for storing a plurality of wafers prior to be transferred to the furnace. At least one cassette receives the wafers from the storage stage by means of a cassette loader for transferring wafers from the wafer storage area to the cassette. A boat receives one or more wafers from the cassettes and loads and supports the wafers in the vertical furnace.

A robot moves one or more wafers from the cassette to the boat and an elevator then moves the boat into the semiconductor furnace. A first sensor, for generating a first electrical signal, has both a receiver and a transmitter section with one of the sections mounted to the base of the boat and the other section mounted in line opposite the base. A second sensor, for generating a second electrical signal, is mounted to the robot and responds to the wafers for ensuring that the wafers are positioned properly in the boat by the robot.

A control system includes a microprocessor having a memory and several input and output ports. The control system responds to the first and second electrical signals connected to different input ports and operable in response to an algorithm stored in the microprocessor for controlling through the output ports the robot, the elevator and the cassette loader to load the wafers in the furnace.

### BRIEF DESCRIPTION OF THE DRAWINGS

These and other objects, features and advantages of the present invention will become apparent from the following detailed description and the appended drawings in which:

FIG. 1 is a schematic of a portion of a semiconductor-manufacturing unit including a vertical furnace;

FIG. 2 is a schematic illustrating the sensor placement in the semiconductor-manufacturing unit of FIG. 1; and

FIG. 3 is bottom view of the quartz boat cap holder used in the present invention.

### DETAILED DESCRIPTION OF THE PREFERRED EMBODIMENT

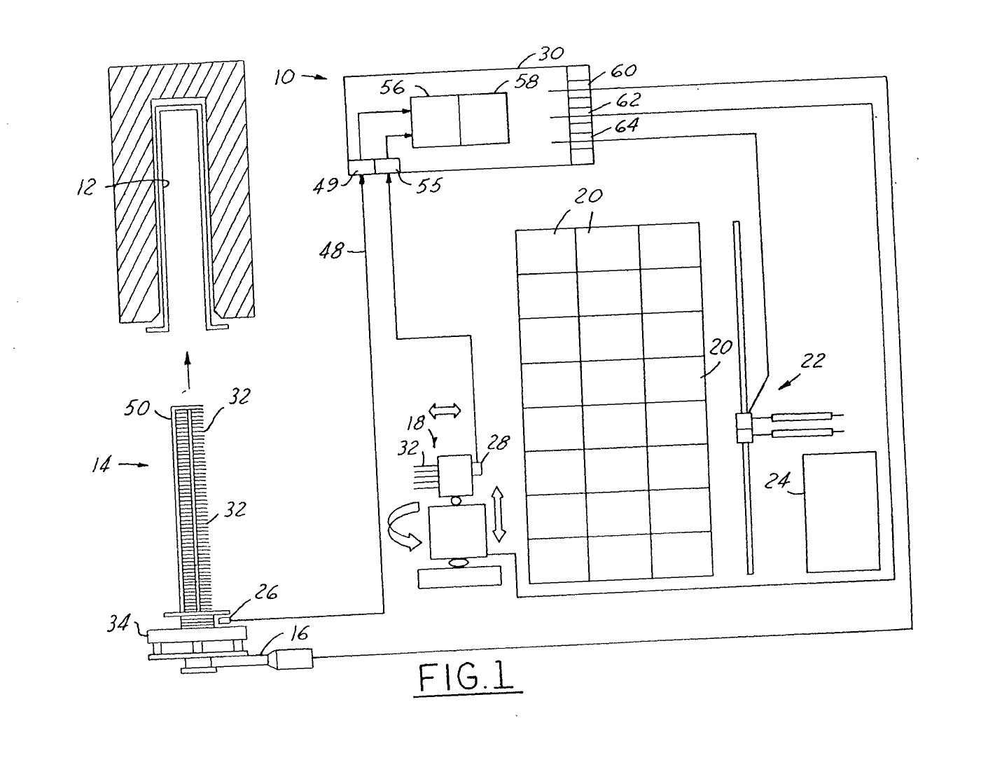

Referring to the Figs by the characters of reference, there is illustrated in FIG. 1 a portion of vertical furnace used in a semiconductor-manufacturing unit 10. In particular, there is illustrated a chamber 12 of the furnace, a boat 14 mounted to an elevator 16, a robot 18, a stack of cassettes 20, a cassette loader 22, a wafer storage area or stage 24, a first sensor 26, a second sensor 28 and a control unit 30.

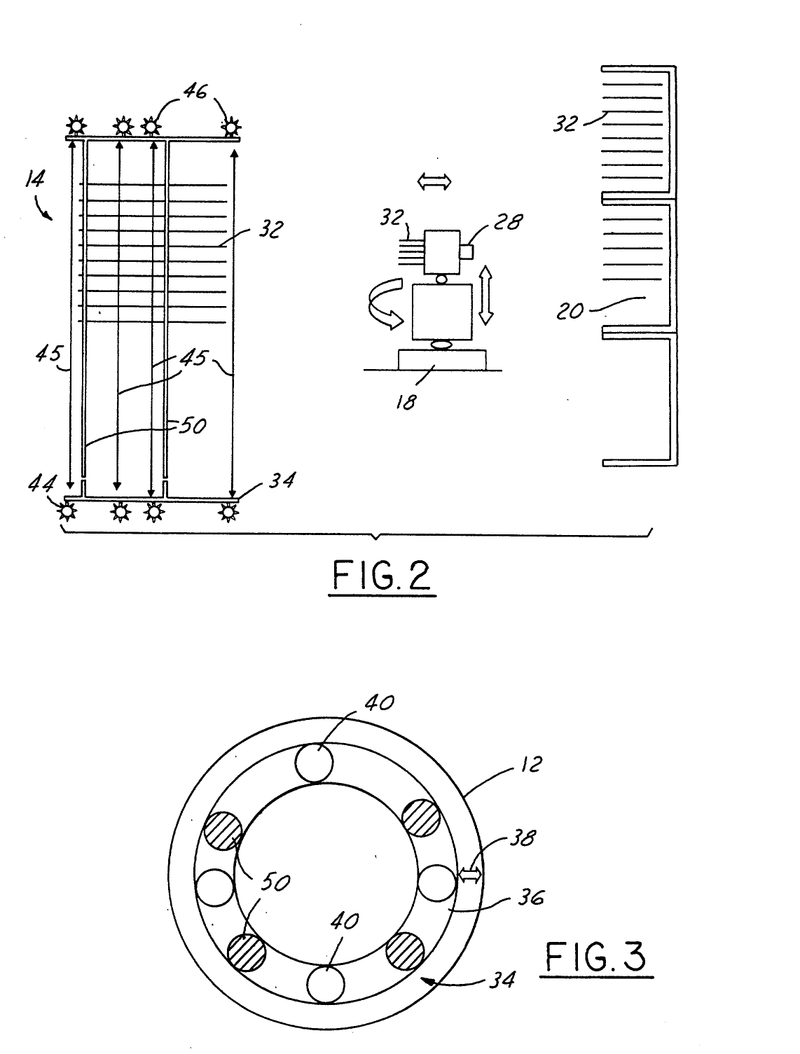

In the processing of semiconductor wafers 32, the wafers are processed through many, many steps from the fabrication of the initial substrate to the finished product. Illustrated in FIG. 1 and FIG. 2 is the portion of the process for loading the chamber 12 in the furnace. As illustrated in several patents, such as U.S. Pat. No. 5,846,073 entitle “Semiconductor Furnace Processing Vessel Base” issued on Dec. 8, 1998, which is incorporated herein by reference only. The chamber 12 is located so that the environmental conditions of the system are closely maintained. These include by way of illustration the cleanness of the chamber, the temperature of the chamber and various other conditions required for the fabrication of semiconductor chips. The chamber 12 is typically an enclosed tubular member opened at one end that is generally the bottom end.

A boat 14 for carrying the wafers 32 into the chamber 12 is located on an elevator 16. The elevator 16 reciprocally moves the boat 14 into and out of the chamber 12 under control of the control unit 30.

A robot 18 is position to transfer the wafers 32 to the boat 14 from the stack of cassettes 20. U.S. Pat. No. 6,002,516 entitled “Vertical Cassette Elevator and Load Lock Viewer” issued Dec. 14, 1999 and U.S. Pat. No. 6,206,441 entitled “Apparatus and Method for Transferring Wafers by Robot” issued on Mar. 27, 2001 both teach the transferring of the wafers 32 to the boat 14. Both of these patents are assigned to a common assignee and are herein incorporated by reference only.

The wafers 32 are stored in a wafer storage area or stage 24 and by means of a cassette loader 22 are transferred to the cassettes 20. This is a prior art system for loading the wafers 32.

By means of the present invention, the position of the wafers 32 in the quartz boat 14 has their alignment checked after the transfer is completed. The alignment of the wafer 32 is checked so that the wafer will be loaded into the chamber 12 with any failures. The present invention operates to prevent any wafer 32 from sliding out of the boat 14 or becoming scratched, broken or dropped due to misalignment. In addition the wafers 32 are continuously checked until it becomes either unnecessary because the boat 14 is in the chamber 12 or the environment of the boat precludes the operation of the sensors 26, 28.

To accomplish these advantages a first sensor 26 is mounted to the base 34 of the boat 14 as illustrated in FIG. 3. The base 34 of the boat has a ring 36 with a diameter that is almost the diameter of chamber 12. In the preferred embodiment there is a five-millimeter (5 mm) gap 38 between the ring 36 and the chamber 12. With such a small gap 38, if a wafer 32 is not aligned properly, the chamber 12 walls may break or physically damage the wafer as the boat 14 is loaded into the chamber.

As shown in FIG. 3, the base 34 has four equally and angularly spaced holes 40 that are aligned with the top plate 42 of the boat 14. Through these holes 40 a photoelectric beam 45 from the first sensor 26 is transmitted from a transmitter 44 to a receiver 46 opposite the base 34 in the boat 14. In the preferred embodiment the first sensor 26 has a transmitter 44 mounted in the base 34. The transmitter 44 generates the photoelectric beam 45 from a light emitting diode, not shown. The receiver 46 is a reflective surface mounted on the top plate 42 wherein the reflective beam from the top plate 42 permits the first sensor 26 to generate a first electrical signal 48 when the wafers 32 are in correct alignment. This first electrical signal 48 is supplied to an input port 49 in the control unit 30. Omron Electronics, Inc of Schaumburg, Ill., manufactures one such sensor, identified by their catalog number 3S-BR11.

Another first sensor 26 may be a laser sensor with the transmitter in the base and the receiver in the top. The fine laser beam 45 can be guided along the peripheral surfaces of the wafers 32 so that if any wafer is not properly aligned or positioned, the receiver will generate a first electrical signal 48 indicating misalignment.

Mounted to the base 34 and extending in a direction into the chamber 12 are a plurality of rails 50, schematically shown in FIGS. 1 and 2, having means such as teeth, not shown, to support the wafers 32. An example of such rails 50 may be found in U.S. Pat. No. 6,095,806 entitled “Semiconductor Wafer Boat and Vertical Heat Treating System” issued on Aug. 1, 2000, which is included herein by reference only.

A second sensor 28 is mounted to the robot 18 for ensuring the position of the wafers 32 after transfer to the boat 14. In particular, the second sensor 28 is an ultrasonic sensor that is physically mounted on the backside of the wafer-handling arm 52 of the robot 18 so as to check the wafer 32 after the robot has positioned it in the boat 14. The second sensor 28 generates an ultrasonic signal of less than 300 kHz, typically approximately 270 kHz. If the wafer 32 is out of position, the reflective signal generates a second electrical signal 54 to an input port 55 of the control unit 30 to halt the operation of the robot 18. Omron Electronics, Inc of Schaumburg, Ill. manufactures one such sensor, identified by their catalog number E4C-LS35 and has an amplifier identified as E4C-WHAL. If the wafer 32 is properly positioned the second electrical signal 54 is generated by the second sensor 28 and supplied to the control unit 30 for allowing continuing operation of the robot 18. The algorithm 58 that is stored in the memory, as is well known in the art, functions to respond to the first 48 and second 54 electrical signals to allow the transferring and storing of the wafers 32. In addition, the algorithm 58 in conjunction with the microprocessor 56 controls one or more output ports 60, 62, 64 to control the elevator 16, the robot 18 and the cassette loader 22.

Since this is typically a digital electronic control system, the first and second electrical signals 48, 54 are pulsed signals and depending on the characteristic of the microprocessor 56 in the control unit 30, the one or zero level is defined by the system designer.

While the present invention has been described in an illustrative manner, it should be understood that the terminology used is intended to be in a nature of words of description rather than of limitation.

Accordingly, various changes and modifications may be made to the illustrative embodiment without departing from the spirit or scope of the invention. It is to be appreciated that those skilled in the art will readily apply these teachings to other possible variations of the inventions. However, it is intended that the scope of the invention not be limited in any way to the illustrative embodiment shown and described but that the invention be limited only by claims appended hereto.

1. A wafer positioning checking system in a vertical semiconductor furnace having a chamber for processing wafers, the system comprising:
a wafer storage stage for storing a plurality of wafers prior to be transferred to the furnace;
at least one cassette for receiving said wafers from said storage stage;
a cassette loader for transferring said wafers from said wafer storage area to said cassette;
a boat adapted to receive said wafers from said cassettes, said boat for loading and supporting said wafers in the vertical furnace, said boat having a top plate and a base plate;
a robot for moving said wafers from said at least one cassette to said boat;
an elevator for moving said boat into the semiconductor furnace chamber;
a first sensor having a receiver section and a transmitter section, one of said sections mounted in the base of said boat and the other of said sections mounted opposite said base, said first sensor generates a first electrical signal;
a second sensor mounted to said robot and responsive to said wafer ensuring that said wafer is positioned in said boat, said second sensor generates a second electrical signal; and
a control system including a microprocessor having a memory and several input and output ports, said system responsive to said first and second electrical signals and operable in response to an algorithm stored in said microprocessor for controlling said robot, said cassette loader and said elevator, for loading said wafers in the furnace.

2. A system according to claim 1 wherein said first sensor is a photoelectric sensor having said transmitter mounted in said base plate of said boat and a reflective surface mounted opposite said transmitter in said top plate.

3. A system according to claim 2 wherein said transmitter transmits a photoelectric beam along the edges of said wafers in said boat and said reflective surface is responsive to properly positioned wafers in said boat for generating said first electrical signal.

4. A system according to claim 3 wherein said photoelectric beam is generated from a light emitting diode mounted in said base plate.

5. A system according to claim 3 wherein said photoelectric beam is generated from a laser mounted in said base plate.

6. A system according to claim 1 wherein said second sensor is an ultrasonic sensor responsive to said wafer after said robot transfers said wafer into said boat for generating a second electrical signal.

7. A system according to claim 6 wherein said second sensor generates an ultrasonic signal of less than 300 kHz.

8. A system according to claim 7 wherein the frequency of said ultrasonic signal is substantially 270 kHz.

9. A system according to claim 1 wherein the algorithm in said control unit responds to said first and second electrical signals to continuously monitor said wafers during the processing of the wafers.
